(19) United States
(12) Patent Application Publication
(10) Pub. No.: US 2007/0276884 A1
(43) Pub. Date: Nov. 29, 2007

(54) Method and apparatus for managing backup data and journal

(75) Inventors: Junichi Hara, Cupertino, CA (US); Akira Yamamoto, Kanagawa (JP)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/439,610

(22) Filed: May 23, 2006

(51) Int. Cl. G06F 17/30

(52) U.S. Cl. 707/204

(57) ABSTRACT

The system includes a host, storage system, and backup media library system. In response to instruction issued by host, storage system selects snapshot and journal entries needed to restore the image of data at the specified time point or within specified time period, and takes a backup of them to the backup media. The storage system manages the backup so that the original data can be restored at a later time. In alternative implementation, the system includes a backup management host, storage system, and backup media library. In response to instruction received from backup management host, storage system selects snapshot and journal entries needed to restore image of data at a specified time point or within specified time period, and returns the data of snapshot and journal entries, and the format of a journal entry. The backup management host takes a backup of the received information to the backup media.

### FIELD OF THE INVENTION

The present invention is related to computer storage systems and in particular to backup and recovery of data.

### DESCRIPTION OF THE RELATED ART

Historically, various methods have been used to prevent loss of data in a data storage volume. A typical and conventional method is to periodically make a backup of data (e.g. once a day) to a backup media (e.g. magnetic tapes). When the data needs to be restored, the data saved in the backup media is read and written to a new volume. However, the above method can only restore the image of the data at the time point when the backup was taken. Therefore, if the restored data is also corrupted, the whole backup data taken at the previous or next period needs to be restored.

Recently, storage systems having a journaling capability have been developed. Journaling is one of the methods to prevent loss of data. In the journaling method, an image of all data in a storage volume at certain time point (usually called snapshot) is created and stored. After the snapshot is created and stored, the history (or a journal) of the changes made to the volume after the time point of the snapshot is maintained. Restoring of the data is accomplished by applying the journal to the snapshot. Therefore, the data can be restored to the image at various points in time. US patent publication number US2004/0268067A1, “Method and Apparatus for Backup and Recovery System Using Storage Based Journaling,” incorporated herein by reference, discloses such a storage system. The disclosed storage system takes periodic snapshots of a volume and maintains a journal of the changes to the volume after the snapshot is taken. Snapshots and journal entries are stored separately from the data volumes. Although such storage system seems to be able to replace conventional backup method, there is still a need to transfer the backup data copy to the backup media in order to preserve the backup data in the event of the storage system failure.

Therefore, what is needed is a technology providing a way to take and comprehensively manage backups of a snapshot and the associated journal at a certain time point or within a time period. Such technology may be utilized in computer storage systems for backup and recovery of data.

### SUMMARY OF THE INVENTION

The inventive methodology is directed to methods and systems that substantially obviate one or more of the above and other problems associated with conventional techniques for backup and recovery of data.

In accordance with an aspect of an inventive methodology, there is provided a computerized system, which includes a storage system coupled to a host via a network interconnect. The host includes a backup controller module. The storage system includes at least one data volume operable to store host data in response to at least one write command from the host; at least one snapshot volume operable to store at least one snapshot image of host data stored in at the least one data volume, the snapshot image being taken at a time point; and at least one journal volume operable to store at least one journal record. The aforesaid journal record includes information on updates to the host data in the data volume since the time point when the at least one snapshot was taken. The storage system additionally includes a controller. The inventive computerized system further includes a data backup system incorporating a backup media, which is coupled to the storage system and is configured to receive backup data from the storage system and to write the backup data to a backup media upon receipt of an instruction from the controller. The backup data includes the aforesaid at least one snapshot and the at least one journal record.

In accordance with another aspect of an inventive methodology, there is provided a computerized system, which includes a first storage system. The storage system is coupled to a host via a network interconnect and includes at least one data volume operable to store host data in response to at least one write command from the host; at least one snapshot volume operable to store at least one snapshot image of host data stored in at the least one data volume and at least one journal volume operable to store at least one journal record. The snapshot image is taken at a time point. The journal record includes information on updates to the host data in the data volume since the time point when the at least one snapshot was taken. The host includes a backup controller module. The inventive computerized system further includes a backup management host and a data backup system including a backup media. The backup system is operatively coupled to the first storage system and a second storage system and operable to receive backup data from the storage system; to write the backup data to a backup media upon receipt of an instruction from the backup management host; and to restore at least a portion of the backup data from the backup medium to the second storage system. The backup data includes the aforesaid at least one snapshot and the at least one journal record.

In accordance with yet another aspect of the inventive methodology, there is provided a computer-implemented method and a computer-readable medium embodying a computer program implementing the aforesaid method. In accordance with the inventive method, a write command from a host is received at a storage system and the host data associated with the write command is written to a data volume. At least one snapshot image of host data stored in the data volume is taken and at least one journal record including information on updates to the host data in the data volume since the time point when the snapshot was taken is stored. When a backup instruction specifying a time is received from the host, at least one snapshot image and at least one journal record necessary to recover a data in a data volume at the specified time is selected and written to a backup medium.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates the first exemplary embodiment of the inventive concept;

FIG. 2 shows an exemplary system configuration of the first embodiment of the inventive concept;

FIG. 3 shows an exemplary functional diagram of the first embodiment of the inventive concept;

FIG. 4 illustrates an exemplary embodiment of journal data;

FIG. 5 illustrates an exemplary embodiment of a Journal Management Table;

FIG. 6 illustrates a relationship between Snapshot and Journal;

FIG. 7 illustrates a relationship between multiple snapshots and Journal;

FIG. 8 illustrates snapshot and journal data needed to restore data at the specified time;

FIG. 9 provides an exemplary flowchart of a procedure for choosing snapshot and journal data needed to restore data at the specified time;

FIG. 10 illustrates an exemplary embodiment of a Backup Management Table;

FIG. 11 illustrates snapshot and journal data needed to restore data within the specified time period;

FIG. 12 provides an exemplary flowchart of a procedure for choosing snapshot and journal data needed to restore data within the specified time period;

FIG. 13 provides an exemplary flowchart of a procedure for taking backup of chosen snapshot and journal data;

FIG. 14 provides an exemplary flowchart of a procedure for restoring data at the specified time from backup data;

FIG. 15 illustrates the second exemplary embodiment of the inventive concept;

FIG. 16 shows an exemplary system configuration of the second embodiment of the inventive concept;

FIG. 17 shows an exemplary functional diagram of the second embodiment of the inventive concept;

FIG. 18 illustrates an exemplary embodiment of a Backup Management Table in accordance with the second exemplary embodiment of the inventive concept;

FIG. 19 illustrates an exemplary embodiment of a hard disk drive;

FIG. 20 shows an exemplary arrangement of journal header and journal data on magnetic tape;

FIG. 21 illustrates an exemplary format of journal entries;

FIG. 22 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### First Embodiment

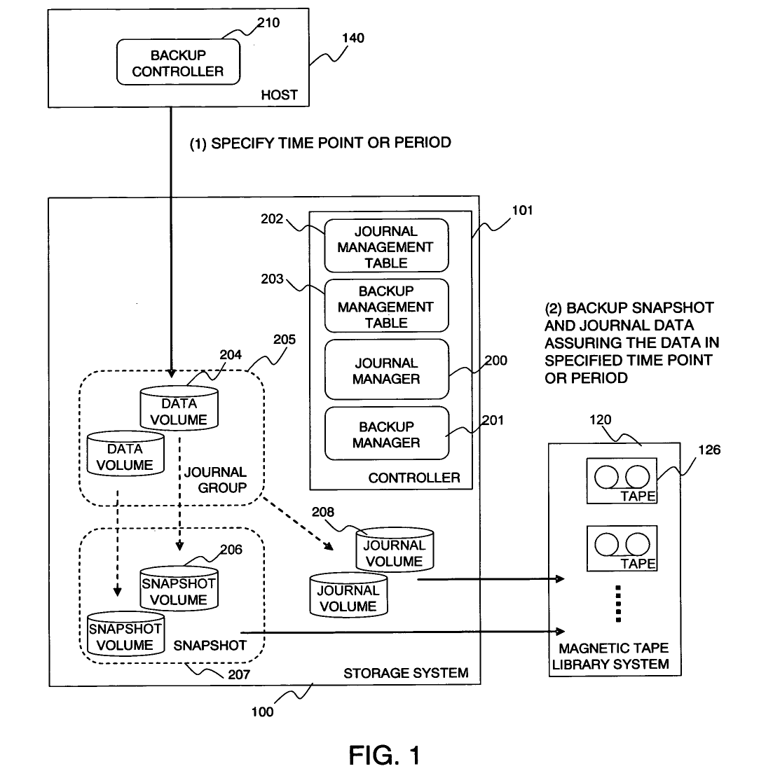

FIG. 1 provides a high-level generalized block diagram of an illustrative embodiment of a backup recovery system in accordance with the inventive concept. When the storage system 100 is activated, a snapshot is taken of the production data volumes 204. The term “snapshot” in this context conventionally refers to a data image of the data volume at a given time point. Depending on system requirements and implementations, as well as other factors, the snapshot can be of the entire data volume, or some portion or portions of the data volume(s). During the normal course of operation of the storage system 100, a journal entry is made for every write operation issued from the host 140 to the data volumes 204. As will be discussed below, by applying a series of journal entries to an appropriate snapshot, data can be recovered in the future for any point in time. In addition, the storage system 100 is configured to take a backup of the snapshot and the journal entries to a magnetic tape 126 in the magnetic tape library system 120 in response to a request from the host 140.

### System Configuration

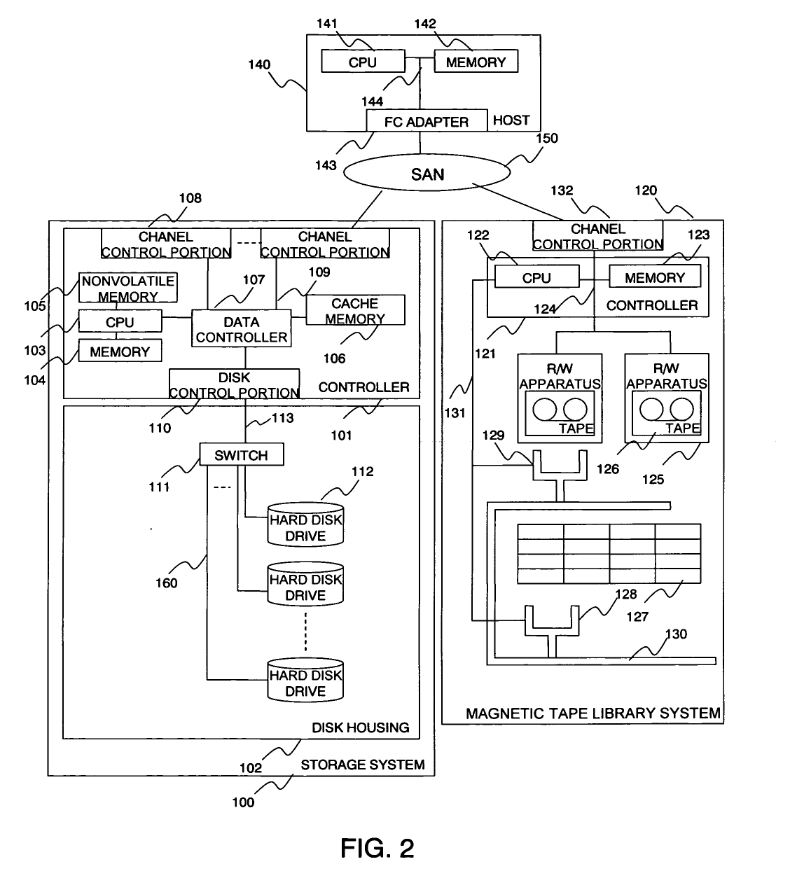

FIG. 2 illustrates an exemplary configuration of the system in which the method of the present invention may be implemented. As shown in FIG. 2, the host 140 is connected to the storage system 100 through a SAN 150. The SAN 150 is composed of switches and cables so as to be able to establish communication conforming to an FC-SW (Fibre Channel Switched Fabric) standard between the host 140 and the storage system 100.

The host 140 can be implemented based on, for example, a personal computer, a workstation, a mainframe computer, or the like. The host 140 comprises a CPU 141, memory 142, and FC adapter 143. The host 140 is connected to the storage system 100 through a fibre channel (FC) adapter 143. Some of the programs embodying the inventive concept are executed by the host 140 using the CPU 141.

The storage system 100 may include a controller 101 and a disk housing 102. The controller 101 comprises a CPU 103, a memory 104, a cache memory 106, channel control portions 108, a data controller 107, a disk control portion 110, and a nonvolatile memory 105. The disk housing 102 comprises a plurality of hard disk drives 112 and a switch 111. As shown in FIG. 19, each hard disk drive 112 has a fibre channel interface implemented using FC adapter 1505, providing a communication function conforming to the FC-SW standard, well known to persons of skill in the art. The hard disk drives 112 in the disk housing 102 are connected to the disk control portion 110 through cables 160 and a switch 111 such as to be able to establish a communication with the disk control portion 110. Also, as shown in FIG. 19, each hard disk drive 112 has a CPU 1500 and memory 1501 to process data input/output requests from the disk control portion 110, as well as a nonvolatile memory 1502 to store various management information and management tables. Finally, each disk drive 112 includes a physical disk 1504, comprising magnetic media physically storing the data. These components are interconnected with an internal bus 1503. The disk control portion 110 is an interface for exchanging data with the hard disk drives 112 in accordance with instructions from the CPU 103. The disk control portion 110 is configured to transmit data input/output requests to the hard disk drives 112 in accordance with the FC-SW (Fibre Channel Switched Fabric) standard, well known to persons of skill in the art. The aforesaid input/output requests control the hard disk drives 112. The CPU 103 controls the overall functions of the storage system 100. To this end, the CPU 103 executes micro-programs stored in the memory 104, so as to control the channel control portions 108, the disk control portion 110, the data controller 107, as well as other system components. The cache memory 106 serves to temporarily store data to be exchanged between each channel control portion 108 and the disk control portion 110. The data controller 107 performs data transfer between each channel control portion 108 and the cache memory 106, or between the cache memory 106 and the disk control portion 110 under the control of the CPU 103. The nonvolatile memory 105 serves to store various management information and management tables. The controller 101 controls the hard disk drives 112 in accordance to a specific RAID level (for example, 0, 1 or 5) in accordance with a so-called RAID (Redundant Arrays of Inexpensive Disks) technology. The RAID system, constructed from a plurality of hard disk drives 112 is managed as one disk group (hereinafter referred to as RAID group). Logical volumes serving as discrete data storage units accessible from the host 140 are formed within each RAID group. An identifier referred to as LUN (Logical Unit Number) is assigned to each logical volume so that such logical volume can be addressed in input/output operations. RAID configuration information is stored in the memory 104, and is used by the CPU 103 when the CPU 103 executes the data READ instruction or the data WRITE instruction. Additionally, in the described embodiment, the controller 101 is configured to act as a coordinator of the journaling of the write operations and the snapshots of the data volumes 204. The disk control portion 110 is connected to the plurality of hard disk drives 112 via a cable 113 and a switch 111 conforming to the FC-SW standard, well known to persons of skill in the art. The fibre channel hard disk drives 112 are connected to the switch 111 by means of plurality of cables 160. Some of the programs embodying the concepts of this invention are executed by the storage system 100, using the CPU 103.

Also as shown in FIG. 2, the storage system 100 is connected to the magnetic tape library system 120 through a storage area network (SAN) 150. The magnetic tape library system 120 is just one example of a data storage unit library system for storing backup data. As would be appreciated by those of skill in the art, other suitable storage systems can be employed to store backup copy of the data and the present invention is not limited to any specific backup storage system.

The magnetic tape library system 120 comprises read/write apparatus 125 for writing and reading information used by the higher-level storage system (in the first embodiment, the higher-level system is the storage system 100) to and from magnetic tapes 126, which, along with optical disks, are examples of a backup data storage unit. The storage library system 120 may also include a rack, holder or shelf 127, which holds magnetic tapes 126. Handlers 128 and 129 travel on a rail 130 to carry magnetic tapes between the read/write apparatus 125 and the shelf 127. A controller 121 controls the operation of the read/write apparatus 125 as well as the handlers 128 and 129 according to the commands or requests from the aforesaid higher-level storage system. The controller 121 may include a CPU 122 and a memory 123.

### Functional Diagram:

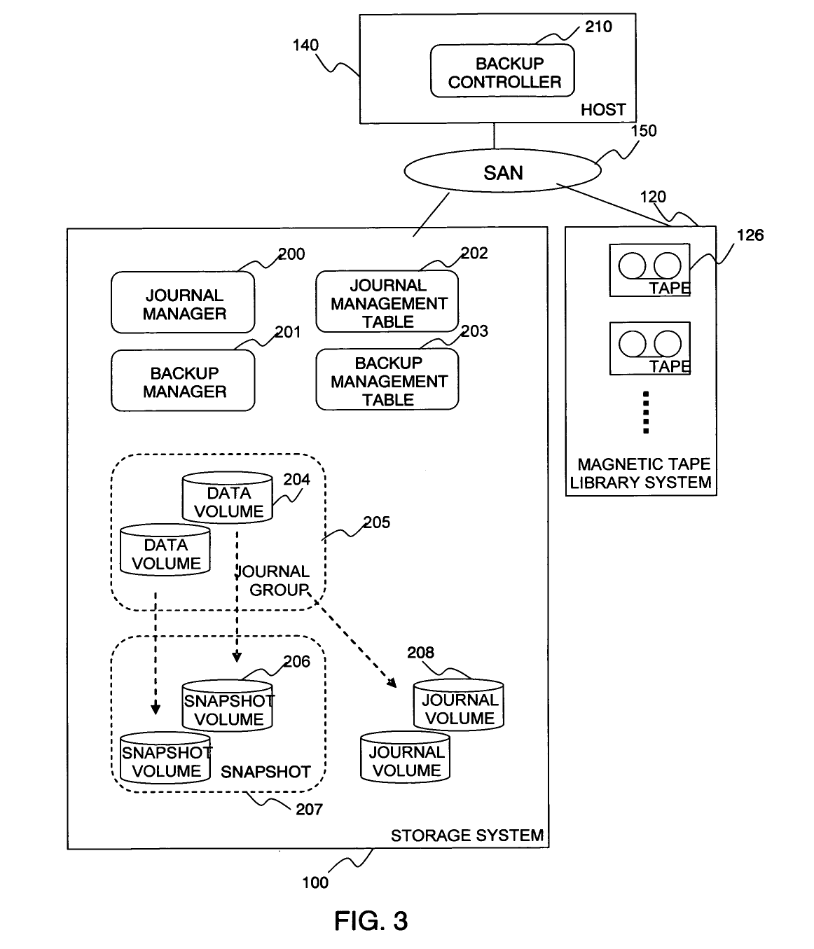

FIG. 3 illustrates an exemplary functional diagram of the storage system in accordance with the first embodiment of the inventive concept. As shown in FIG. 3, the host 140 includes a Backup Controller 210, which sends a backup request specifying a time point or a time period to the storage system 100 in accordance with input received from users (or administrators) of the host 140.

The components of the storage system 100 include Journal Manager 200, Journal Management Table 202, Backup Manager 201, and Backup Management Table 203. The Journal Manager 200 takes storage volume snapshots and maintains journal entries using the Journal Management Table 202. The Backup Manager 201 creates backups of sets of snapshots and journal entries on magnetic tapes 126 within the magnetic tape library system 120, as will be discussed in detail below.

### Snapshot and Journal Entries

The data volumes 204 are organized into the journal group 205, which is the smallest unit of the data volumes 204, with respect to which the journaling of the write operations from the host 140 to the data volumes 204 is guaranteed. The associated journal records reflect the proper order of write operations from the host 140 to the data volumes 204. The journal data generated by the journaling functionality of the inventive storage system can be stored in one on or more journal volumes 208.

The storage system 100 creates a snapshot 207 of the data volumes 204 comprising a journal group 205. For example, the snapshot 207 reflects the contents of the data volumes 204 in the journal group 205 at the time point when the snapshot was taken. There exist several methods for producing a snapshot image, which are well known to persons of skill in the art. One or more snapshot volumes 206 containing the snapshot data are provided within the storage system 100. A generated snapshot can be stored in one or more snapshot volumes 206. Additionally, a journal management table 202 is provided to store the information relating to the journal group 205, the snapshot 207, and the journal volume(s) 208.

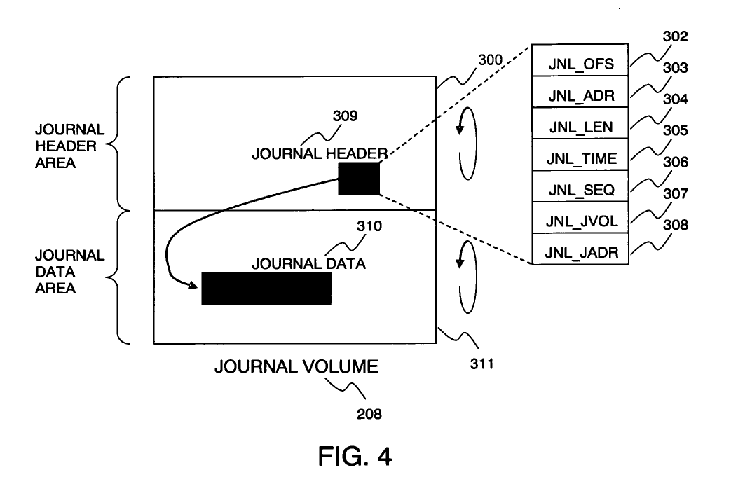

FIG. 4 illustrates exemplary information used in an exemplary implementation of the journal. The journal is generated in response to a write request received by the storage system 100 from the host 140. The journal comprises a Journal Header 309 and Journal Data 310. The Journal Header 309 contains information about the corresponding Journal Data 310 associated with the journal header. The Journal Data 310 includes the data (write data) that is the subject of the write operation. This type of journal is also referred to as an “AFTER journal.”

As shown in FIG. 4, The Journal Header 309 comprises an offset number (JNL_OFS) 320, an address (JNL_ADR) 303, a data length (JNL_LEN) 304, a write time (JNL_TIME) 305, a sequence number (JNL_SEQ) 306, a journal volume identifier (JNL_JVOL) 307, and a journal data address (JNL_JADR) 308.

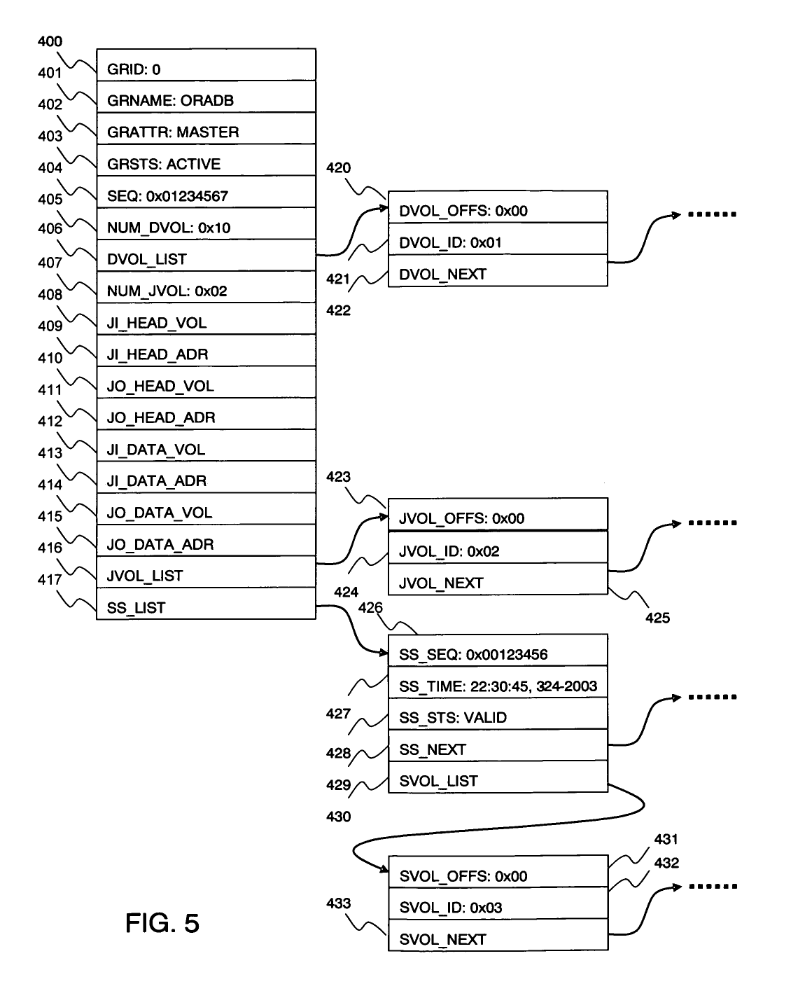

The offset number JNL_OFS 302 identifies a particular data volume 204 in the journal group 205. The data volumes are numbered staring with 0th data volume, the first data volume, the second data volume and so on. The offset numbers might be 0, 1, 2, etc. JNL_OFS 302 identifies which data volume 204 in the journal group 205, which was the subject of the write operation. The offset number corresponds to DVOL_OFFS 420 in FIG. 5, and is determined when the journal entry is made in response to a write operation.

JNL_ADR 303 identifies a starting address in the data volume 204 to which the write data is to be written. For example, the address can be represented as a block number (LBA, Logical Block Address).

JNL_LEN 304 represents the data length of the write data. Typically it is represented as a number of blocks.

JNL_TIME 305 represents the time when the write request arrives at the storage system 100. The write time may include the calendar day, hour, minute, second, and even millisecond. This time can be provided by the controller 101 or the host 140.

JNL_SEQ 306 is a number assigned to each write request. Every sequence number within a given journal group 205 is unique. The sequence number is assigned to a journal entry when it is created.

JNL_JVOL 307 identifies the journal volume 208 associated with the Journal Data 310. The identifier is indicative of the journal volume containing the Journal Data 310. It is noted that the Journal Data 310 can be stored in a journal volume that is different from the journal volume containing the Journal Header 309.

JNL_JADR 308 contains the beginning address of the Journal Data 310 in the associated journal volume 208 containing the Journal Data 310.

FIG. 4 shows that the journal volume 208 comprises two data areas: a Journal Header Area 300 and a Journal Data Area 311. The Journal Header Area 300 contains only Journal Headers 309, and Journal Data Area 311 contains only Journal Data 310. The Journal Header 309 is a fixed size data structure. A Journal Header 309 is allocated sequentially from the beginning of the Journal Header Area 300. This sequential organization corresponds to the chronological order of the journal entries. As will be discussed, data is provided that points to the first journal entry in the list, which represents the “oldest” journal entry. It is typically necessary to find the Journal Header 309 for a given sequence number (as stored in the sequence number field JNL_SEQ 306) or for a given write time (as stored in the time field JNL_TIME 305).

Journal Header 309 and Journal Data 310 are contained in chronological order in their respective areas in the journal volume 208. Thus, the order in which the Journal Header 309 and the Journal Data 310 are stored in the journal volume 208 is the same order as the assigned sequence number. The journal information 309, 310 wrap within their respective areas 300, 311.

### Journal Management Table:

FIG. 5 shows details of the journal management table 202. In order to manage the Journal Header Area 300, and the Journal Data Area 311, pointers for each area are needed. As mentioned above, the journal management table maintains configuration information of journal groups 205 and the relationship among the journal group, its associated journal volume(s) 208, and snapshot image 207.

The journal management table 202 shown in FIG. 5 illustrates an example management table and its contents. The journal management table 202 stores a journal group ID (GRID) 400, a journal group name (GRNAME) 401, a journal attribute (GRATTR) 402, a journal status (GRSTS) 403, a sequence number (SEQ) 404, number of data volumes (NUM_DVOL) 405, a data volume list (DVOL_LIST) 406, the number of journal volumes (NUM_JVOL) 407, JI_HEAD_VOL 408, JI_HEAD_ADR 409, JO_HEAD_VOL 410, JO_HEAD_ADR 411, JI_DATA_VOL 412, JI_DATA_ADR 413, JO_DATA_VOL 414, JO_DATA_ADR 415, a list of journal volumes (JVOL_LIST) 416, and a list of snapshot images (SS_LIST) 417.

GRID 400 indicates a particular journal group 205 in the storage system 100. The ID is assigned by the journal manager 200 in the storage system 100 when users or administrators of the storage system 100 define the particular journal group 205.

GRNAME 401 identifies the journal group 205 with a human recognizable identifier. The name is input by users or administrators of the storage system 100 and saved in the field by the journal manager 200 when the users or the administrators define the particular journal group 205.

GRATTR 402 is associated with the journal group 205. It can indicate two attributes: MASTER and RESTORE. The MASTER attribute indicates the journal group 205 is being journaled. The RESTORE attribute indicates that the journal group is being restored from a journal.

GRSTS 403 is associated with the journal group 205. It can indicate two statuses: ACTIVE and INACTIVE.

SEQ 404 is a counter which serves as the source of sequence numbers used in the Journal Header 309. When creating a new journal, the SEQ field 404 is read and assigned to the new journal. Then, the SEQ 404 is incremented and written back to the journal management table 202.

NUM_DVOL 405 indicates the number of data volumes 204 contained in a given journal group 205.

DVOL_LIST 406 lists the data volumes 204 in the journal group 205. In a particular implementation, DVOL_LIST 406 is a pointer to the first entry of a data structure which holds the data volume information as seen in FIG. 5. Each data volume information comprises an offset number (DVOL_OFFS) 420. For example, if the journal group 205 comprises three data volumes 204, the offset values could be 0, 1 and 2. The offset value is assigned to each data volume 204 by the journal manager 200 when the data volume 204 is added to the journal group 205 by users or administrators of the storage system 100. A data volume identifier (DVOL_ID) 421 uniquely identifies a data volume within the entire storage system 100. Also, when users or administrators of the storage system 100 add a data volume 204, they specifies the data volume 204 using the data volume identifier. A pointer (DVOL_NEXT) 422 points to the data structure holding information for the next data volume 204 in the journal group 205; it is a NULL value otherwise.

NUM_JVOL 407 indicates the number of journal volumes 208 that are used to contain the journal data header 309 and the journal data 310 associated with the journal group 205.

JI_HEAD_VOL 408 identifies the journal volume 208 that contains the Journal Header Area 300 which will store the next new Journal Header 309.

JI_HEAD_ADR 409 identifies an address of the location on the journal volume 208 where the next Journal Header 309 will be stored.

JO_HEAD_VOL 410 identifies the journal volume 208 which stores the Journal Header Area 300 containing the oldest Journal Header 309.

JO_HEAD_ADR 411 identifies the address of the location of the Journal Header 309 within the Journal Header Area 300 containing the oldest journal.

JI_DATA_VOL 412 identifies the Journal Data Area 311 in which the next Journal Data 310 will be stored.

JI_DATA_ADR 413 identifies the specific address in the Journal Data Area 311 where the next Journal Data 310 will be stored.

JO_DATA_VOL 414 identifies the journal volume 208 which stores the Journal Data Area 311 containing the data of the oldest journal.

JO_DATA_ADR 415 identifies the address of the location of the oldest Journal Data 310 within the Journal Data Area 311.

JVOL_LIST 416 contains a list of journal volumes 208 associated with a particular journal group 205. In a particular implementation, JVOL_LIST 416 is a pointer to a data structure of information for journal volumes 208. As shown in FIG. 5, each data structure comprises an offset number (JVOL_OFS) 423 which identifies a particular journal volume 208 associated with a given journal group 205. For example, if a journal group is associated with two journal volumes 208, then each journal volume might be identified by a 0 or 1. A journal volume identifier (JVOL_ID) 424 uniquely identifies the journal volume 208 within the storage system 100. Finally, a pointer (JVOL_NEXT) 425 points to the next data structure entry pertaining to the next journal volume associated with the journal group; it is a NULL value otherwise.

SS_LIST 417 is a list of snapshot images 207 associated with a given journal group 205. In this particular implementation, SS_LIST 417 is a pointer to snapshot information data structure, as shown in FIG. 5. Each snapshot information data structure includes a sequence number (SS_SEQ) 426 that is assigned when the snapshot is taken. A time value (SS_TIME) 427 indicates the time when the snapshot was taken. A status (SS_STS) 428 is associated with each snapshot; valid values include VALID and INVALID. A pointer (SS_NEXT) 429 points to the next snapshot information data structure; it is a NULL value otherwise. Each snapshot information data structure also includes a list of snapshot volumes (SS_LIST) 417 which is used to store the snapshot images 207. As shown in FIG. 5, a pointer to (SVOL_LIST) 430 to a snapshot volume information data structure is stored in each snapshot information data structure. Each snapshot volume information data structure includes an offset number (SVOL_OFFS) 431 which identifies a snapshot volume containing at least a portion of the snapshot image. It is possible that a snapshot image will be segmented or otherwise partitioned and stored in more than one snapshot volumes. In this particular implementation, the offset identifies the i-th snapshot volume containing a portion (segment, partition, etc) of the snapshot image might be stored in the i-th snapshot volume. Each snapshot volume information data structure further includes a snapshot volume identifier (SVOL_ID) 432 that uniquely identifies the snapshot volume in the storage system 100, and a pointer (SVOL_NEXT) 433 that points to the next snapshot volume information data structure for a given snapshot image.

### Relationship Between Journal Entries and Snapshots:

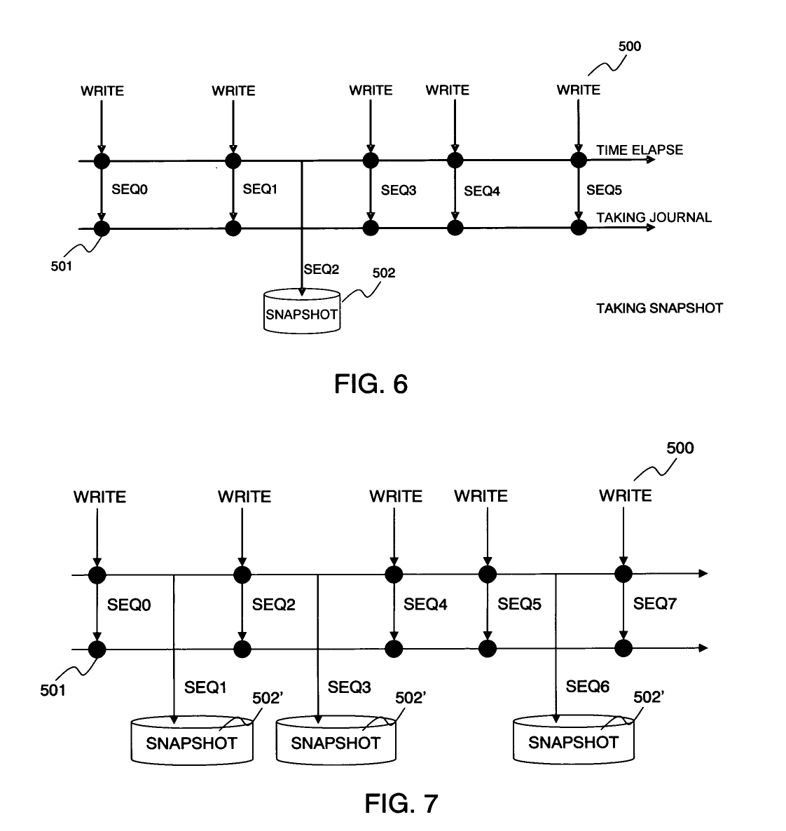

FIG. 6 illustrates the relationship between journal entries and snapshots. The snapshot 502 represents the first snapshot image of the data volumes 204 belonging to a journal group 205. Note that journal entries 501 having sequence numbers SEQ0 and SEQ1 have been made, and represent journal entries for two write operations. These entries show that journaling has been initiated at a time prior to the snapshot being taken. Thus, at a time corresponding to the sequence number SEQ2, the backup controller 210 initiates the taking of a snapshot, and since journaling has been initiated, any write operations occurring during the taking of the snapshot are journaled. Thus, the write operations 500 associated with the sequence numbers SEQ3 and higher show that those operations are being journaled. As an observation, the journal entries identified by sequence numbers SEQ0 and SEQ1 can be discarded or otherwise ignored.

### Restoring From Snapshots and Journal Entries:

Restoring data typically requires recovering the data state of at least a portion of the data volumes 204 at a specific time. Generally, this is accomplished by applying one or more journal entries to a snapshot (or update or overwrite a part of the snapshot according to one or more journal entries) that was taken earlier in time relative to the journal entries. In the particular implementation, the SEQ 404 is incremented each time and assigned to a journal entry or to a snapshot. Therefore, it is a simple matter to identify which journal entries can be applied to a selected snapshot; i.e., those journal entries whose associated sequence number (JNL_SEQ) 306 are greater than the sequence number (SS_SEQ) 426 associated with the selected snapshot.

For example, the administrator may specify some time point, presumably a time that is earlier than the time at which the data in the data volume 204 was lost or otherwise corrupted. The time field SS_TIME 427 for each snapshot is searched until a time earlier than the target time is found. Next, the Journal Headers 309 in the Journal Header Area 300 is searched, beginning from the “oldest” Journal Header 309. The oldest Journal Header can be identified by the “JO_” fields 410, 411, 414, and 415 in the journal management table 202. The Journal Headers are searched sequentially in the area 300 for the first header whose sequence number JNL_SEQ 306 is greater than the sequence number SS_SEQ 426 associated with the selected snapshot. The selected snapshot is incrementally updated by applying each journal entry, one at a time, to the snapshot in sequential order, thus reproducing the sequence of write operations. This continues as long as the time field JNL_TIME 305 of the journal entry is prior to the target time. The update ceases with the first journal entry whose time field 305 is past the target time.

In accordance with one aspect of the particular implementation, a single snapshot is taken. All journal entries subsequent to that snapshot can then be applied to reconstruct the data state at a given time. In accordance with another aspect of the particular implementation, multiple snapshots 502′ are taken. Each snapshot and journal entry is assigned a sequence number in the order in which the object (snapshot or journal entry) is recorded. It can be appreciated that since there typically will be many journal entries 501 recorded between each snapshot 502′, having multiple snapshot allows for quicker recovery time for restoring data. The snapshot closest in time to the target recovery time would be selected. The journal entries made subsequent to the snapshot could then be applied to restore the desired data state.

### Selecting Snapshot and Journal Entries to Backup:

When taking a backup of the snapshot 207 and the journal entries, users or administrators on the host 140 sends a backup request of a journal group 205 with a particular time point or period. The journal group 205 is specified with the same ID as GRID 400 or with the same name as GRNAME 401. In response to the backup command, the storage system 100 selects the Snapshot 207 and journal entries so that it can restore the image of the journal group 205 at the time point or within the time period specified by the host 140.

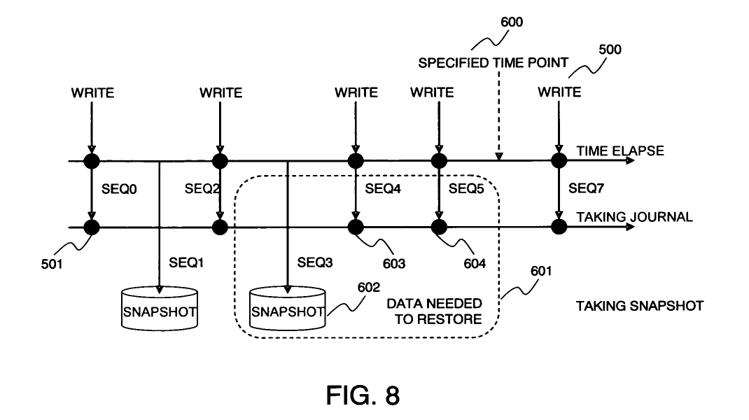

FIG. 8 shows a result of selecting snapshot and journal entries in response to the backup request from the host 140. In this case, the host 140 specified the time point 600 as the time point at which the image of journal group 205 must be assured. The backup of the snapshot 602 and the journal entries 603 and 604 will be taken.

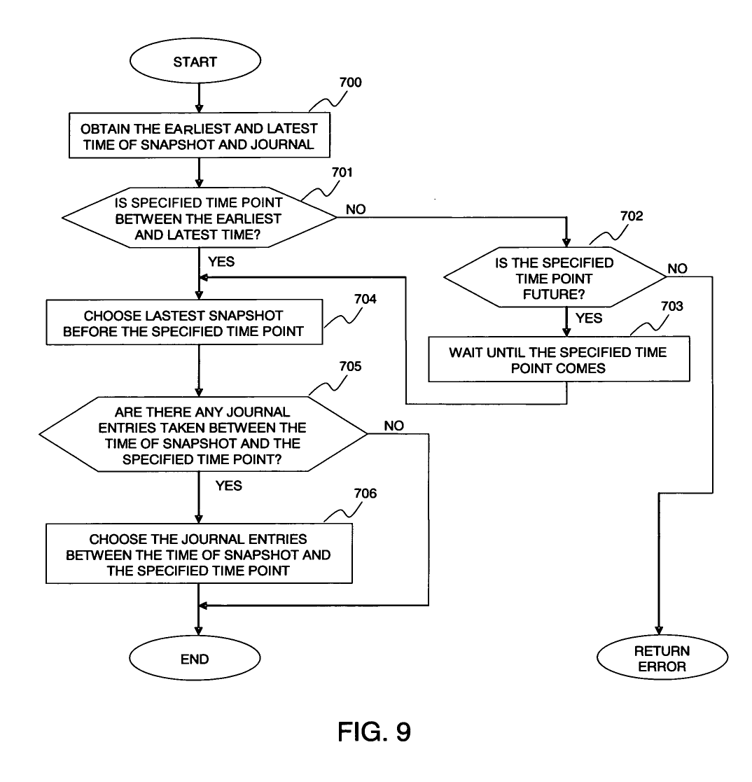

FIG. 9 shows a flow diagram of selecting snapshot and journal entries in response to a backup request with a particular time point.

Step 700: the backup manager 201 gets the earliest and the latest time point of snapshot and journal. It can be archived by checking the SS_TIME 427 and the JNL_TIME 305 fields of all the snapshot and journal entries.

Step 701: the backup manager 201 checks if the time point specified by the host 140 is between the earliest and the latest time point obtained in step 700. If the specified time point is between the earliest and the latest time point, it proceeds to step 704. Otherwise it proceeds to step 702.

Step 702: the backup manager 201 checks if the time point specified by the host 140 is future or not. It can be archived by comparing the specified time point with the present time managed by the controller 101. If the specified time point is future, it proceeds to step 703. Otherwise it returns the error because there's no snapshot or journal maintained in the storage system 100 to assure the data image at the specified time point.

Step 703: the backup manager 201 waits until the specified time comes.

Step 704: the backup manager 201 selects the latest snapshot before the time point specified by the host 140.

Step 705: the backup manager 201 checks if there are any journal entries made between the time of the snapshot chosen in step 704 and the specified time point. If there are, it proceeds to step 706. Otherwise, it ends the process.

Step 706: the backup manager 201 selects all the journal entries between the time of the snapshot chosen in step 704 and the time point specified by the host 140.

FIG. 11 shows a result of selecting a snapshot and journal entries in response to the backup request from the host 140. In this case, the host 140 specified the time period 800 as the time period in which the image of data volume 204 must be assured. In FIG. 11, the time period 800 begins with time point 801 and ends with time point 802. The snapshot and journal data needed to recreate an image of the volume 204 at any time during the time period 800 is designated in FIG. 11 with numeral 803. Therefore, as shown in FIG. 11, the backup of the snapshots 804, 805, and the journal entries 806, 807, 808 will be taken.

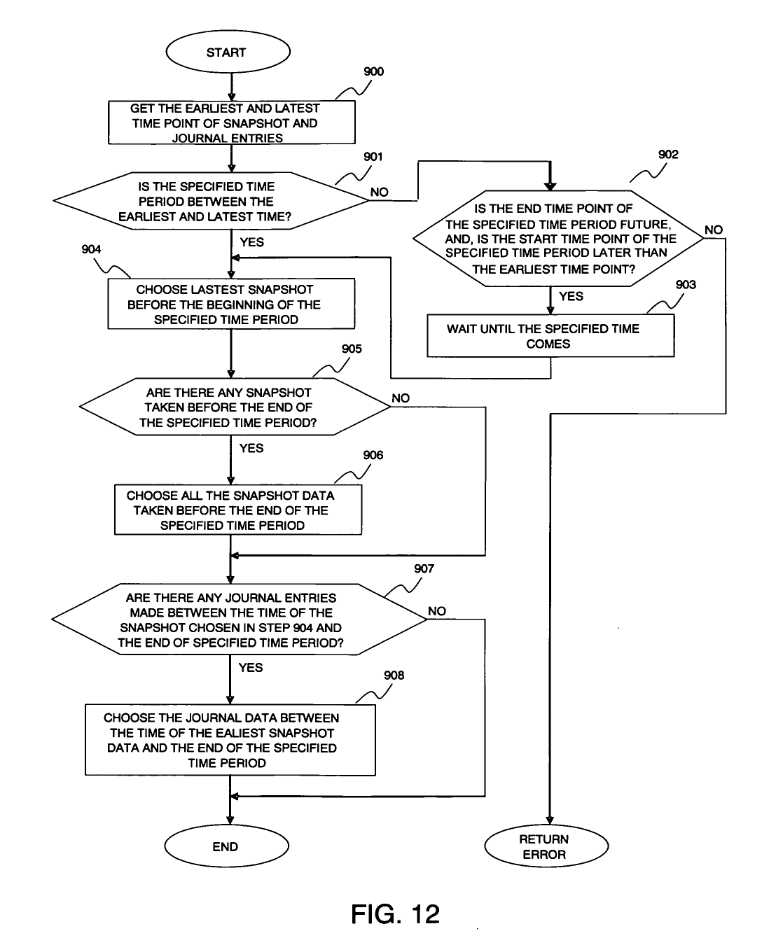

FIG. 12 shows a flow diagram of selecting snapshot and journal entries in response to a backup request with a particular time period.

Step 900: the backup manager 201 gets the earliest and the latest time point of snapshot and journal. It can be archived by checking the SS_TIME 427 and the JNL_TIME 305 fields of all the snapshot and journal entries.

Step 901: the backup manager 201 checks if the time period specified by the host 140 is within the earliest and the latest time point obtained in step 900. If the specified time period is within the earliest and the latest time point, it proceeds to step 904. Otherwise it proceeds to step 902.

Step 902: the backup manager 201 checks if the end time of the time period specified by the host 140 is future or not, and if the start time of the time period specified by the host 140 is later than the earliest time point. It can be archived by comparing the end time with the present time managed by the controller 101, and the start time with the earliest time point. If the end time is future, it proceeds to step 903. Otherwise, it returns error because there's no snapshot or journal maintained in the storage system 100 to assure the data image within the specified time period.

Step 903: the backup manager 201 waits until the end of the specified time period comes.

Step 904: the backup manager 201 selects the latest snapshot before the beginning of the time period specified by the host 140.

Step 905: the backup manager 201 checks if there are any snapshots taken between the time point of the snapshot selected in step 904 and the end time of the time period specified by the host 140. If there are, it proceeds to step 906. Otherwise, it proceeds to step 907.

Step 906: the backup manager 201 selects all the snapshots taken between the time point of the snapshot chosen in step 904 and the end time of the time period specified by the host 140.

Step 907: the backup manager 201 checks if there are any journal entries made between the time of the snapshot chosen in step 904 and the end time of the time period specified by the host 140. If there are, it proceeds to step 908. Otherwise, it ends the process.

Step 908: the backup manager 201 selects all the journal entries made between the time of the snapshot selected in step 904 and the end time of the time period specified by the host 140.

### Backup to a Magnetic Tape:

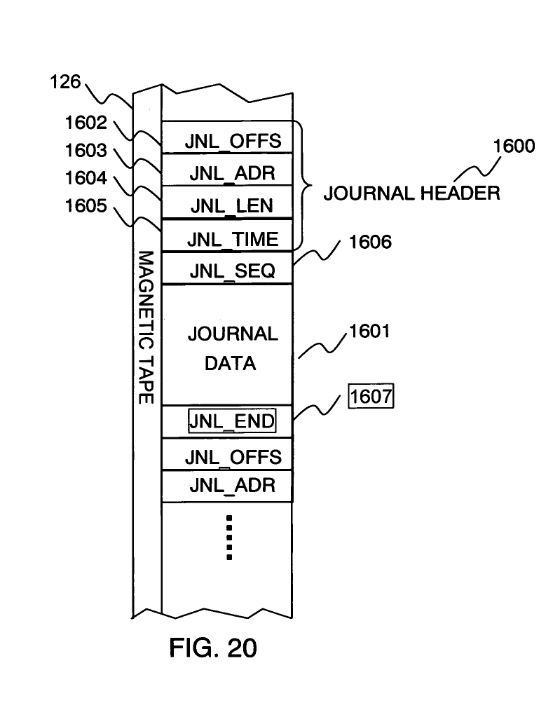

Because conventional magnetic tapes 126 store data in sequential manner, the Journal Header 309 and the Journal Data 310 need be arranged in a specific order in order to be written to the magnetic tapes 126. FIG. 20 shows an exemplary arrangement of the Journal Header 309 and the Journal Data 310.

Journal Header 1600 is very similar to the Journal Header 309 described with reference to the first embodiment. However, some of the header information is not needed for backup. The list below specifies information included in the backup of each journal entry:

JNL_OFS 1602: the same as JNL_OFS 302.

JNL_ADR 1603: the same as JNL_ADR 303.

JNL_LEN 1604: the same as JNL_LEN 304.

JNL_TIME 1605: the same as JNL_TIME 305.

JNL_SEQ 1606: the same as JNL_SEQ 306.

JNL_END 1607: this field indicates the end of journal data. In a particular implementation, this field is filled with a magic number for showing the end of journal data.

Journal Data 1601: the same as the journal data 310.

In the first embodiment, the controller arranges the Journal Header 309 and the Journal Data 310 and sends the arranged data to the magnetic tape library system 120, then, the magnetic tape library system 120 writes the data to magnetic tapes 125. In response to the write request to the magnetic tape library system 120, the magnetic tape library system 120 returns the ID of the magnetic tape 125 so that the magnetic tape 125 can be distinguished from other ones later.

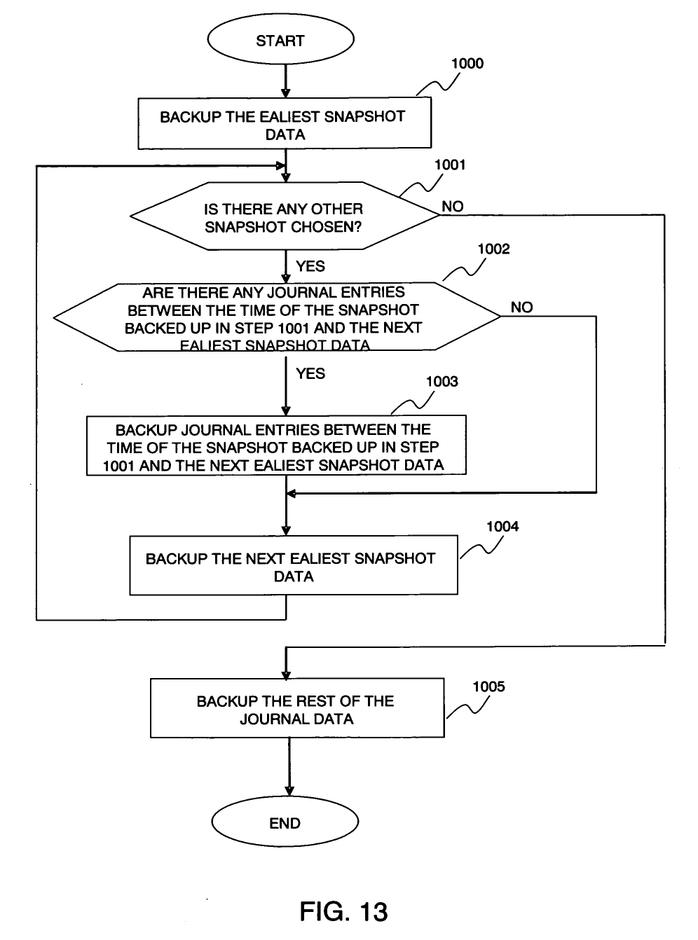

The backup manager 201 takes a backup of the snapshot and journal entries in the order of time point of the snapshot and journal entries form the oldest to the latest. FIG. 13 shows the flow diagram of taking a backup of the selected snapshot and journal entries.

Step 1000: the backup manager 201 takes a backup of the earliest snapshot in the snapshot selected as the result of the processing flow in FIG. 9 or FIG. 12.

Step 1001: the backup manager 201 checks if there is any other snapshot selected as the result of the processing flow in FIG. 9 or FIG. 12. If there is, it proceeds to step 1002. Otherwise, it proceeds to step 1004.

Step 1002: the backup manager 201 checks if there are any journal entries made between the time of the snapshot backed up in step 1001 and the next earliest snapshot. If there are, it proceeds to step 1003. Otherwise, it proceeds to step 1004.

Step 1003: the backup manager 201 takes a backup of the journal entries made between the time of the snapshot which is backed up in step 1001 and the time of the next earliest snapshot.

Step 1004: the backup manager 201 takes a backup of the next earliest snapshot.

Step 1005: the backup manager 201 takes a backup of the rest of the journal entries.

### Backup Management Table:

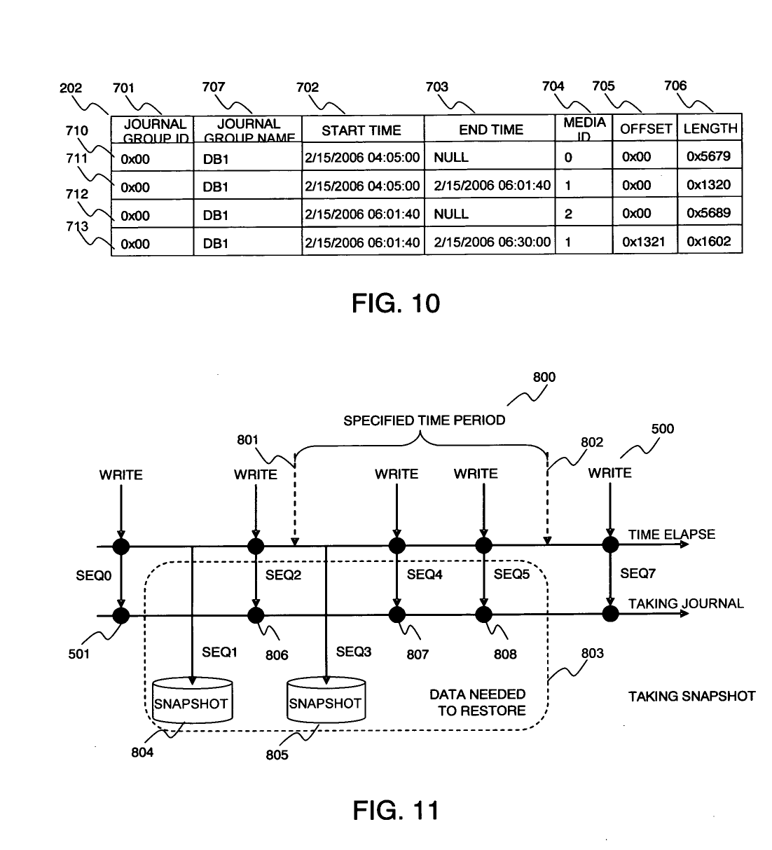

When taking a backup of the snapshots and the journal entries, the backup manager 201 makes an entry (row 710 to 713) for each snapshot and a series of journal entries on the backup management table 202 in FIG. 10.

Journal Group ID 701: The same ID as the GRID 400.

Journal Group Name 707: The same name as the GRNAME 401.

Start Time 702: in case that the entry is for a backup of a snapshot, the time point that the snapshot is taken is written in this field. In case that the entry is for a backup of a series of journal entries, the time point of the snapshot right before the earliest time point that the series of journal entries that are backed up is written in this field.

End Time 703: in case that the entry is for a backup of a snapshot, NULL will be written in this field. In case that the entry is for a backup of a series of journal entries, the latest time point that the series of journal entries that are backed up is written in this field. If there is another snapshot to be backed up after the journal entries, the time point of the snapshot is written in this field so that it can indicate that there are not journal entries that is not backed up between the last journal entry and the next snapshot.

Media ID 704: the ID of magnetic tape 126 used to save the snapshot or the series of journal entries. This is returned from Magnetic Tape Library System 120.

Offset 705: the offset within the magnetic tape 126 from which the snapshot or the series of journal entries are stored.

Length: 706: the length (typically blocks or bytes) of data of the snapshot or the series of journal entries, which are saved in the magnetic tape 126.

### Restoring From Backup of Snapshots and Journal Entries:

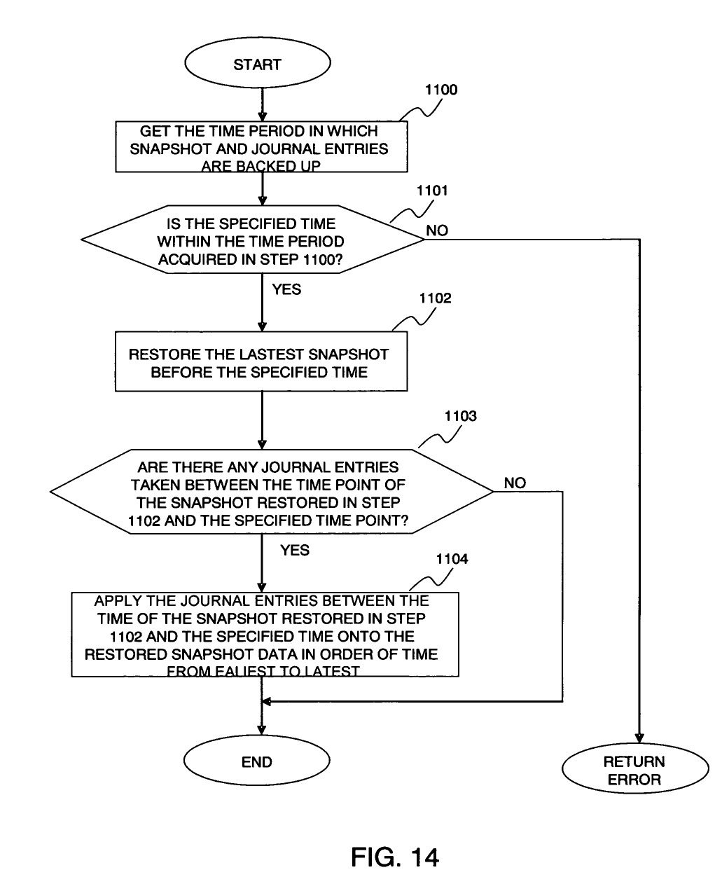

When restoring from backup of snapshot and journal entries stored in magnetic tapes, users or administrators on the host 140 send a restore request to the storage system 100 with the journal group ID or journal group name and a time point of data image of a journal group to be restored. In response to the request, the backup manager 201 in the storage system 100 restores the data image from the backup of snapshots and journal entries. FIG. 14 shows the flow diagram of restoring data image of a journal group from backup of snapshots and journal entries.

Step 1100: the backup manager 201 gets the time period in which snapshots and journal entries are backed up. It can be achieved by searching Start Time 702 and End Time 703 fields. If there is a time gap, it means that the data in the time gap is not backed up (data image in the time gap is not assured by backup data).

Step 1101: the backup manager 201 checks if the time point specified by the host 140 falls into the time period acquired in step 1100. If it does, it proceeds to step 1102. Otherwise, it returns error because the data image at the specified time can not be restored.

Step 1102: the backup manager 201 restores the latest snapshot before the time point specified by the host 140.

Step 1103: the backup manager 201 checks if there are any journal entries made between the time point of the snapshot restored in step 1102 and the time point specified by the host 140. If there are, it proceeds to step 1104. Otherwise, it ends the process.

Step 1104: the backup manager 201 applies the journal entries made between the time point of the snapshot restored in step 1102 and the time point specified by the host 140 in order of time from earliest to latest.

### Second Embodiment

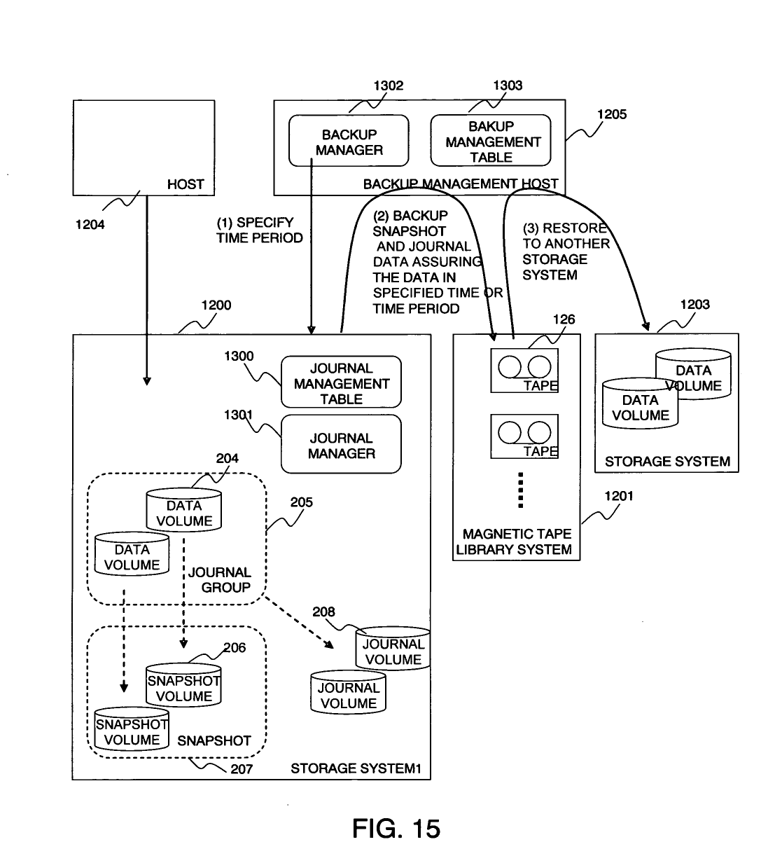

FIG. 15 provides a high-level generalized block diagram of another illustrative embodiment of a backup and recovery system according to another aspect of the present invention. The primary difference of the second embodiment from the first embodiment is that the backup request is sent from a backup management host 1205, and, in response to the received backup request, the storage system 1200 returns the appropriate snapshot and journal entries to the backup management host 1205. As in the first embodiment, the snapshot(s) and journal entries returned by the storage system 1200 insure the recovery of the data in the storage volume at the time point or within the time period specified by the backup management host 1205. The backup management host 1205 then saves the returned data to magnetic tapes 126 in the magnetic tape library system 1201 and manages the backup data using the backup management table 1303. By storing and managing the backup data on the backup management host 1205, connected to the network, the data can be restored to a different storage system 1203, which doesn't have a journaling capability. In addition, in response to the request from the backup management host, the storage system 1200 returns the format of journal entries, and the backup management host 1205 saves and manages the format information, which enables it to manage journal entries in a different formats sent from different storage systems.

### System Configuration

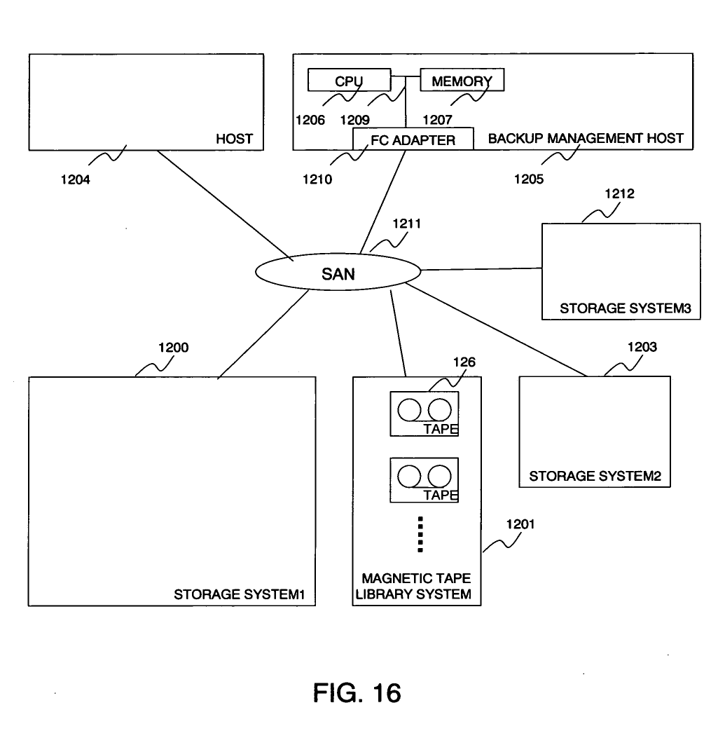

FIG. 16 shows an example configuration of the system in which the method of the present invention is applied. As shown in FIG. 16, the host 1204 is connected to the storage system1 1200 through a SAN 1211. The SAN 1211 is composed of switches and cables in the same manner as the first embodiment. The host 1204 and the storage system1 1200 have the same components as the host 140 and the storage system 100 in the first embodiment.

In the second embodiment, the backup management host 1205 is also connected to the storage system 1200 through the SAN 1211. The backup management host 1205 comprises a CPU 1206, a memory 1207, and FC Adapter 1210. Also, the magnetic disk library system 1201 is present and connected to the backup management host 1205. The magnetic disk library system 1201 has the same components as the one 120 in the first embodiment. In the second embodiment, the storage system2 1203 and the storage system3 1212 which are different from the storage system1 1200 are also present. The storage system2 1203 has the same components as the storage system1 1200, but it doesn't have the journaling capability. And the storage system3 1212 has the same components and the journaling capability as the storage system1 1200, but the format of journal entries is different from the storage system1 1200

### Functional Diagram

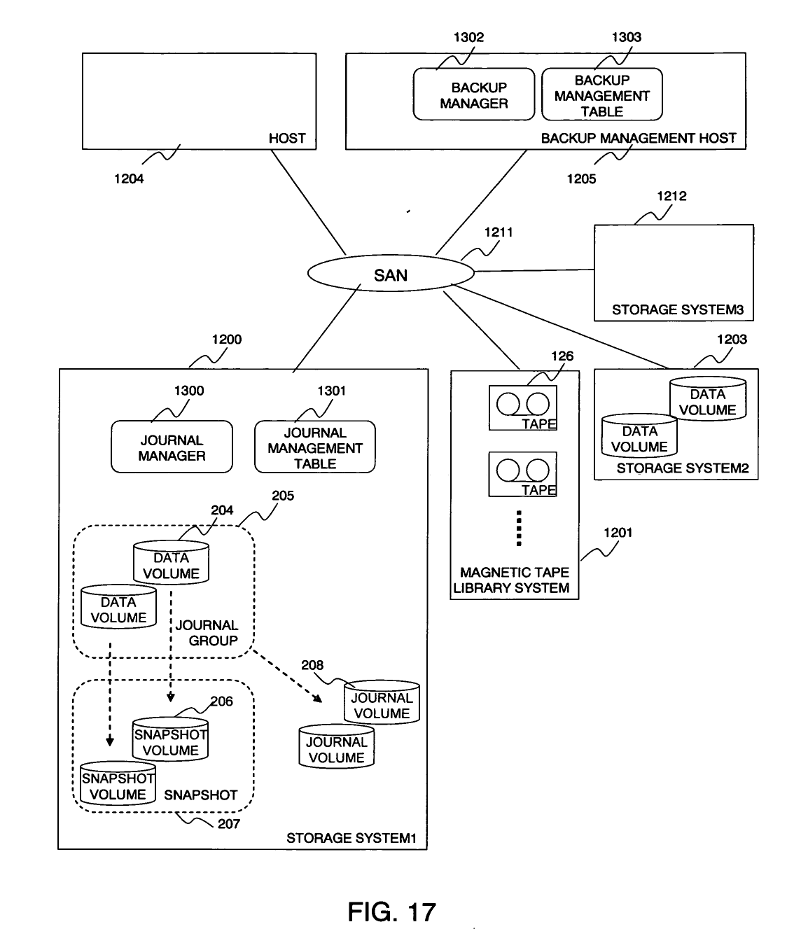

FIG. 17 shows a functional diagram of the system in the second embodiment.

In the backup management host 1205, there is a backup manager 1302, which selects an appropriate time point or a time period to assure the recovery of data to the storage system 1200 in accordance with a recovery request received from the users (or administrators) at the backup management host 1302. Also, the Backup Manager 1302 manages the backup data stored in the magnetic tape library system 1201 using a Backup Management Table 1303 in such a way that the users can restore the data at a later time using the backup data.

The storage system 1200 includes a journal manager 1300 and a journal management table 1301. The journal manager 1300 takes snapshots and maintains journal of volumes using the journal management table 1301 in the same manner as in the first embodiment.

### Selecting Snapshot and Journal Entries to Backup

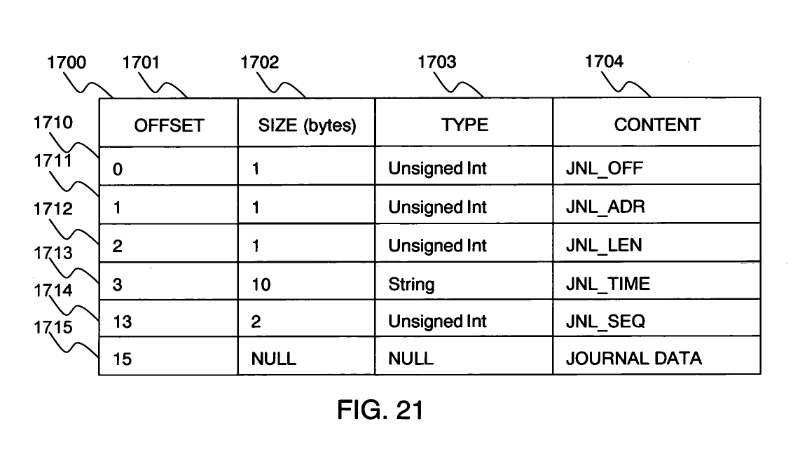

When taking a backup of the snapshot 207 and the journal entries, users or administrators using the backup management host 1205 issue a backup request of a journal group 205. The backup request is accompanied by a particular time point or period information. The journal group 205 is specified with the same ID as GRID 400 or the same name as GRNAME 401, described in detail in connection with the first embodiment. In response to the backup command, the storage system 1200 selects the snapshot 207 and the corresponding journal entries and returns them to the backup management host 1205 so that the backup management host 1205 can restore the image of the journal group 205 at the selected time point or within the selected time period. Before returning the journal entries, the storage system 1200 reformats each journal entry into the format shown in FIG. 20. Also, when returning journal entries, the storage system 1200 returns the information on the format of each journal entry shown in FIG. 21. In response, the Backup Manager 1302 assigns an arbitrary name to the format and saves it in the backup management host 1204.

An operational flow of a process for choosing and taking a backup of the snapshot and journal entries, and the process for restoring the backup data are the same as the first embodiment. However, the processes for selecting snapshots and journal entries are performed by the Journal Manager 1300 on the Storage System 1200, and the processes for taking a backup and restoring of the snapshots and journal entries are performed by the Backup Manager 1302 on the Backup Management Host 1303. Also, when restoring the snapshots and journal entries, the Backup Manager 1302 refers to the format information saved in the backup management host 1204 in order to recognize the location where each journal entry is stored on each magnetic tape 126.

### Backup Management Table

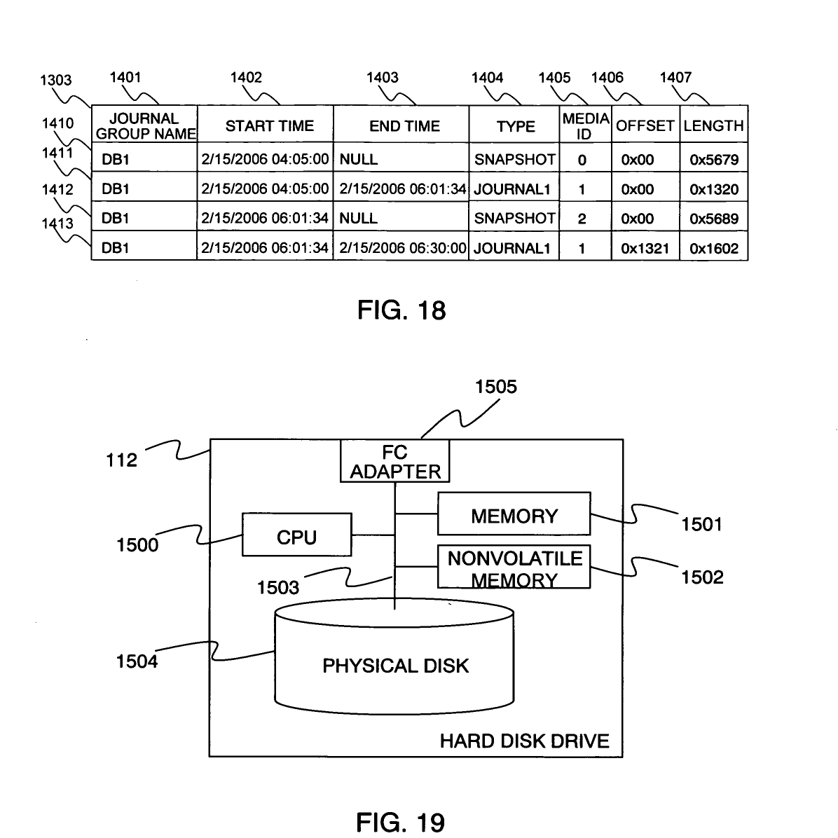

FIG. 18 illustrates an exemplary implementation of the backup management table 1302 of the second embodiment. The backup management table 1303 of the second embodiment is slightly different from the table 203 in the first embodiment. Because the backup manager 1302 may take a backup of snapshots and journal entries of other storage systems, it needs to manage the format (as seen in FIG. 21) of the journal entries for each backup of journal entries. The Backup Manager 1302 will save the format information returned from the storage system 1200 as the response to the backup request, and manages it by putting an arbitrary name (Type 1404) for the format.

Journal Group Name 1401: same as the one 707 in the first embodiment.

Start Time 1402: same as the one 702 in the first embodiment.

End Time 1403: same as the one 703 in the first embodiment.

Type 1404: the arbitrary name of the format of the journal entries. The arbitrary name is assigned by the Backup Manager 1302 when the storage system 1200 returns the format of journal entries shown in FIG. 21 in response to the backup request from the backup management host 1204.

Media ID 1405: same as the one 704 in the first embodiment.

Offset 1406: same as the one 705 in the first embodiment.

Length 1407: same as the one 706 in the first embodiment.

Rows 1410-1413 of the table 1303 include exemplary backup records.

FIG. 21 depicts table 1700, illustrating an exemplary format of information returned from the storage system 1200 to the backup management host 1205.

OFFSET 1701 represents an offset from the start of each journal entry where the field starts.

SIZE 1702 represents a size of the field in bytes.

TYPE 1703 represents data type of the field.

CONTENT 1704 indicates what is written in the field.

Rows 1710-1715 of the table 1700 include examples of the information format data returned from the storage system 1200 to the backup management host 1205.

### HARDWARE PLATFORM EXAMPLE

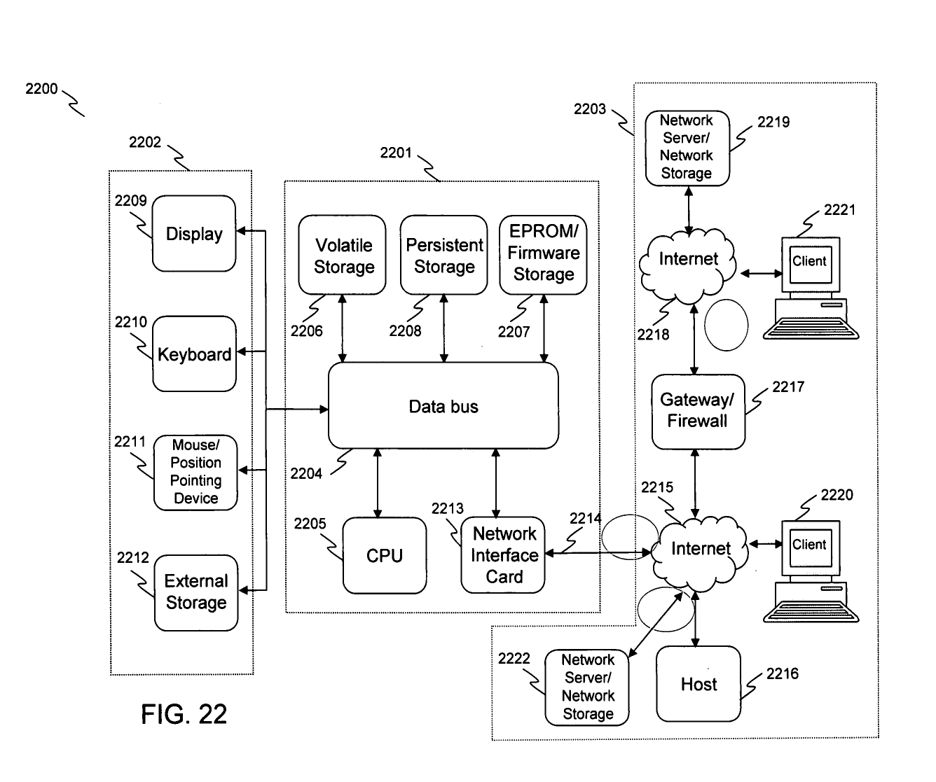

FIG. 22 is a block diagram that illustrates an embodiment of a computer/server system 2200 upon which an embodiment of the inventive methodology may be implemented. The system 2200 includes a computer/server platform 2201, peripheral devices 2202 and network resources 2203.

The computer platform 2201 may include a data bus 2204 or other communication mechanism for communicating information across and among various parts of the computer platform 2201, and a processor 2205 coupled with bus 2201 for processing information and performing other computational and control tasks. Computer platform 2201 also includes a volatile storage 2206, such as a random access memory (RAM) or other dynamic storage device, coupled to bus 2204 for storing various information as well as instructions to be executed by processor 2205. The volatile storage 2206 also may be used for storing temporary variables or other intermediate information during execution of instructions by processor 2205. Computer platform 2201 may further include a read only memory (ROM or EPROM) 2207 or other static storage device coupled to bus 2204 for storing static information and instructions for processor 2205, such as basic input-output system (BIOS), as well as various system configuration parameters. A persistent storage device 2208, such as a magnetic disk, optical disk, or solid-state flash memory device is provided and coupled to bus 2201 for storing information and instructions.

Computer platform 2201 may be coupled via bus 2204 to a display 2209, such as a cathode ray tube (CRT), plasma display, or a liquid crystal display (LCD), for displaying information to a system administrator or user of the computer platform 2201. An input device 2210, including alphanumeric and other keys, is coupled to bus 2201 for communicating information and command selections to processor 2205. Another type of user input device is cursor control device 2211, such as a mouse, a trackball, or cursor direction keys for communicating direction information and command selections to processor 2204 and for controlling cursor movement on display 2209. This input device typically has two degrees of freedom in two axes, a first axis (e.g., x) and a second axis (e.g., y), that allows the device to specify positions in a plane.

An external storage device 2212 may be connected to the computer platform 2201 via bus 2204 to provide an extra or removable storage capacity for the computer platform 2201. In an embodiment of the computer system 2200, the external removable storage device 2212 may be used to facilitate exchange of data with other computer systems.

The invention is related to the use of computer system 2200 for implementing the techniques described herein. In an embodiment, the inventive system may reside on a machine such as computer platform 2201. According to one embodiment of the invention, the techniques described herein are performed by computer system 2200 in response to processor 2205 executing one or more sequences of one or more instructions contained in the volatile memory 2206. Such instructions may be read into volatile memory 2206 from another computer-readable medium, such as persistent storage device 2208. Execution of the sequences of instructions contained in the volatile memory 2206 causes processor 2205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2208. Volatile media includes dynamic memory, such as volatile storage 2206. Transmission media includes coaxial cables, copper wire and fiber optics, including the wires that comprise data bus 2204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2205 for execution. For example, the instructions may initially be carried on a magnetic disk from a remote computer. Alternatively, a remote computer can load the instructions into its dynamic memory and send the instructions over a telephone line using a modem. A modem local to computer system 2200 can receive the data on the telephone line and use an infra-red transmitter to convert the data to an infra-red signal. An infra-red detector can receive the data carried in the infra-red signal and appropriate circuitry can place the data on the data bus 2204. The bus 2204 carries the data to the volatile storage 2206, from which processor 2205 retrieves and executes the instructions. The instructions received by the volatile memory 2206 may optionally be stored on persistent storage device 2208 either before or after execution by processor 2205. The instructions may also be downloaded into the computer platform 2201 via Internet using a variety of network data communication protocols well known in the art.

The computer platform 2201 also includes a communication interface, such as network interface card 2213 coupled to the data bus 2204. Communication interface 2213 provides a two-way data communication coupling to a network link 2214 that is connected to a local network 2215. For example, communication interface 2213 may be an integrated services digital network (ISDN) card or a modem to provide a data communication connection to a corresponding type of telephone line. As another example, communication interface 2213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2213 sends and receives electrical, electromagnetic or optical signals that carry digital data streams representing various types of information.

Network link 2213 typically provides data communication through one or more networks to other network resources. For example, network link 2214 may provide a connection through local network 2215 to a host computer 2216, or a network storage/server 2222. Additionally or alternatively, the network link 2213 may connect through gateway/firewall 2217 to the wide-area or global network 2218, such as an Internet. Thus, the computer platform 2201 can access network resources located anywhere on the Internet 2218, such as a remote network storage/server 2219. On the other hand, the computer platform 2201 may also be accessed by clients located anywhere on the local area network 2215 and/or the Internet 2218. The network clients 2220 and 2221 may themselves be implemented based on the computer platform similar to the platform 2201.

Local network 2215 and the Internet 2218 both use electrical, electromagnetic or optical signals that carry digital data streams. The signals through the various networks and the signals on network link 2214 and through communication interface 2213, which carry the digital data to and from computer platform 2201, are exemplary forms of carrier waves transporting the information.

Computer platform 2201 can send messages and receive data, including program code, through the variety of network(s) including Internet 2218 and LAN 2215, network link 2214 and communication interface 2213. In the Internet example, when the system 2201 acts as a network server, it might transmit a requested code or data for an application program running on client(s) 2220 and/or 2221 through Internet 2218, gateway/firewall 2217, local area network 2215 and communication interface 2213. Similarly, it may receive code from other network resources.

The received code may be executed by processor 2205 as it is received, and/or stored in persistent or volatile storage devices 2208 and 2206, respectively, or other non-volatile storage for later execution. In this manner, computer system 2201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A computerized system comprising:
a. a storage system coupled to a host via a network interconnect, the host comprising a backup controller module; the storage system comprising:
i. at least one data volume operable to store host data in response to at least one write command from the host;
ii. at least one snapshot volume operable to store at least one snapshot image of host data stored in at the least one data volume, the snapshot image being taken at a time point;
iii. at least one journal volume operable to store at least one journal record, the journal record comprising information on updates to the host data in the data volume since the time point when the at least one snapshot was taken;
iv. a controller; and
b. a data backup system comprising a backup media, the backup system operatively coupled to the storage system and operable to receive backup data from the storage system, the backup data comprising the at least one snapshot and the at least one journal record, and to write the backup data to a backup media upon receipt of an instruction from the controller.

2. The computerized system of claim 1, wherein the controller is configured to select the at least one snapshot and the at least one journal of the backup data in response to receipt of a backup instruction from the backup controller module of the host.

3. The computerized system of claim 2, wherein the backup instruction specifies a backup time point and wherein the controller selects the at least one snapshot and the at least one journal of the backup data such that the host data at the backup time point can be recovered from the backup data.

4. The computerized system of claim 2, wherein the backup instruction specifies a backup time period and wherein the controller selects the at least one snapshot and the at least one journal of the backup data such that the host data during the backup time period can be recovered from the backup data.

5. The computerized system of claim 1, wherein the data volumes are grouped into at least one journal group and wherein the controller comprises a journal management table storing configuration information on the journal groups and a relationship between each journal group, a journal volume associated with the journal group and a snapshot image associated with the journal group.

6. The computerized system of claim 1, wherein the controller comprises a backup manager, the backup manager is operable to receive a backup instruction from the host and instruct the data backup system to take a backup of the backup data.

7. The computerized system of claim 1, wherein:
the at least one journal record comprises a journal header and journal data, the journal data comprising information on the at least one update to the host data contained in a write operation received from the host and wherein the journal header comprises information about the corresponding journal data;
the backup media comprises a magnetic tape; and
wherein the data backup system is operable to sequentially write at least a portion of the journal header and the journal data of the at least one journal record onto the magnetic tape.

8. The computerized system of claim 1, wherein the data backup system is operable to recover a state of the data volume at a specified time point.

9. The computerized system of claim 8, wherein during the recovery, the data backup system is operable to read at least one snapshot image and at least one journal record from the backup media and transfer the read snapshot image and the journal record to the controller, and wherein the controller is operable to apply the read journal record to the snapshot image to obtain the state of the data volume at the specified time point.

10. The computerized system of claim 8, wherein the data backup system is operable to recover the state of the data volume at the specified time point to a second storage system, different from the storage system.

11. The computerized system of claim 1, wherein the controller comprises a backup management table, the backup management table comprising at least one entry corresponding to each snapshot and each group journal records of the backup data written to the backup media.

12. The computerized system of claim 11, wherein the at least one entry of the backup management table comprises:
a. A journal group identifier identifying a journal group corresponding to the backup data;
b. A journal group name of the journal group corresponding to the backup data;
c. A start time indicating a snapshot image time or a start time of the group of journal entries;
d. An end time indicating an-end time of the group of journal entries;
e. A media identifier identifying the backup media storing the backup data;
f. An offset indicating a position of the backup data on the backup media; and
g. A length of the backup data.

13. A computerized system comprising:
a. a first storage system coupled to a host via a network interconnect, the host comprising a backup controller module; the first storage system comprising:
i. at least one data volume operable to store host data in response to at least one write command from the host;
ii. at least one snapshot volume operable to store at least one snapshot image of host data stored in at the least one data volume, the snapshot image being taken at a time point;
iii. at least one journal volume operable to store at least one journal record, the journal record comprising information on updates to the host data in the data volume since the time point when the at least one snapshot was taken;
b. a backup management host; and
c. a data backup system comprising a backup media, the backup system operatively coupled to the first storage system and a second storage system and operable to:
i. receive backup data from the storage system, the backup data comprising the at least one snapshot and the at least one journal record;
ii. to write the backup data to a backup media upon receipt of an instruction from the backup management host; and
iii. to restore at least a portion of the backup data from the backup medium to the second storage system.

14. The computerized system of claim 13, wherein the first storage system is operable to receive a backup instruction from the backup management host, the backup instruction specifying a backup time point and wherein, in response to the received backup instruction, the first storage system is operable to select the at least one snapshot and the at least one journal record of the backup data such that the host data at the backup time point can be recovered from the backup data and to furnish the backup data to the backup management host.

15. The computerized system of claim 14, wherein the first storage system is further operable to furnish format information of the at least one journal record to the backup management host.

16. The computerized system of claim 15, wherein the backup management host is further operable to:
a. receive the backup data from the first storage system;
b. to furnish the received backup data to the data backup system; and
c. to receive the format information of the at least one journal record from the first storage system and to store the received format information.

17. The computerized system of claim 13, wherein the data backup system is operable to:
i. Receive a restore command from the backup management host, the restore command specifying a backup time point
ii. Select backup data stored on the backup media such that the host data at the backup time point can be recovered from the backup data and to furnish the backup data to the backup management host.

18. The computerized system of claim 14, wherein the backup management host is further operable to receive the backup data from the data backup system and to furnish the received backup data to the second storage system.

19. The computerized system of claim 18, wherein the backup management host is further operable to convert the journal records of the received backup data from a first journal record format of the first storage system to a second journal record format of the second storage system.

20. A method comprising:
a. Receiving, at a first storage system, at least one write command from a host;
b. Writing host data associated with the at least one received write command to a data volume;
c. Taking at least one snapshot image of host data stored in the data volume;
d. Storing at least one journal record, the journal record comprising information on updates to the host data in the data volume since the time point when the at least one snapshot was taken;
e. Receiving a backup instruction from the host, the backup instruction specifying a time;
f. Selecting at least one snapshot image and at least one journal record necessary to recover data in the data volume at the specified time; and
g. Writing the selected snapshot image and at least one journal record to a backup media.

21. The method of claim 20, wherein the specified time is a time point.

22. The method of claim 20, wherein the specified time is a time period.

23. The method of claim 20, further comprising recovering at least a portion of the host data in the data volume at a specified recovery time, the recovering comprises reading at least one snapshot image and at least one journal record from the backup media and applying the at least one journal entry to the at least one snapshot image.

24. The method of claim 23, further comprising writing the recovered host data to the data volume.

25. The method of claim 23, wherein the recovering of at least a portion of the host data is performed to a second storage system, different from the first storage system.

26. The method of claim 25, further comprising converting the journal records read from the backup media from a first journal record format of the first storage system to a second journal record format of the second storage system.

27. The method of claim 21, wherein the selecting comprises:
i. Determining earliest time and latest time of snapshot images and journal entries;
ii. Checking whether the specified time is between the earliest time and the latest time;
iii. If the specified time is after the latest time, and the specified time is in the future, waiting until the specified time comes;
iv. If the specified time is between the earliest time and the latest time, selecting latest snapshot image before the specified time; and
v. Additionally selecting all journal entries, if any, between a time point of the selected snapshot image and the specified time.

28. The method of claim 22, wherein the selecting comprises:
i. Determining earliest time and latest time of snapshot images and journal entries;
ii. Checking whether the specified time period is between the earliest time and the latest time;
iii. If end time of the specified time period is after the latest time, and the end time of the specified time period is in the future, waiting until the end time of the specified time period comes;
iv. If the specified time period is between the earliest time and the latest time, selecting latest snapshot image before beginning time of the specified time period;
v. Additionally selecting all snapshot images, if any, between the time of the selected snapshot image and the end time of the specified time period; and
vi. Additionally selecting all journal entries, if any, between the time of the snapshot image selected in iv. and the end of the specified time period.

29. The method of claim 20, further comprising inserting, for each snapshot and each set of journal records written to the backup media, at least one entry into a backup management table, the entry comprising:
i. A journal group identifier identifying a journal group corresponding to the backup data;
ii. A name of the journal group corresponding to the backup data;
iii. A start time indicating a snapshot image time or a start time point of the group of journal entries;
iv. An end time indicating an end time point of the group of journal entries;
v. A media identifier identifying the backup media storing the backup data;
vi. An offset indicating a position of the backup data on the backup media; and
vii. A length of the backup data.
